(19) United States
(12) Patent Application Publication
(10) Pub. No.: US 2008/0178799 A1
(43) Pub. Date: Jul. 31, 2008

(54) TWO-LAYER CURTAIN COATER SYSTEM

(76) Inventors: Hiroyuki Kohno, Fukushima (JP); Akio Hirano, Chiba (JP); Hirofumi Morita, Tokyo (JP)

Correspondence Address: TAYLOR & AUST, P.C., P.O. Box 560, 142. S Main Street, Avilla, IN, 46710, US

(21) Appl. No.: 11/668,897

(22) Filed: Jan. 30, 2007

(51) Int. Cl. B05C 5/02

(52) U.S. Cl. 118/313

(57) ABSTRACT

The present invention provides a 2-layer curtain coater that supplies a 2-layered paint curtain formed from a first paint curtain and a second paint curtain to the surface of a transported web to overcoat a first paint and a second paint in two layers on the surface of the web, the 2-layer curtain coater being able to prevent paint loss during coating preparation. The 2-layer curtain coater includes a first curtain nozzle for the forming of the first paint curtain and a second curtain nozzle for the forming of the second paint curtain and, in addition, in that the first curtain nozzle and the second curtain nozzle are relatively movable between a segregated coating preparation position and a merged coating operation position wherein, in the coating preparation position, the first paint and the second paint are recovered in a state independent of each other by the recovery of the first paint curtain from the first curtain nozzle by way of a first recovery pan and the recovery of the second paint curtain from the second curtain nozzle by way of a second recovery pan and, in the coating operation position, the 2-layered paint curtain is formed from the first paint curtain from the first curtain nozzle and the second paint curtain from the second curtain nozzle to overcoat the first paint and the second paint in two layers on the surface of the web.

### BACKGROUND OF THE INVENTION

1. Field of the Invention

The present invention relates to a 2-layer curtain coater that supplies a 2-layered paint curtain formed from a first paint curtain and a second paint curtain to the surface of a transported web to overcoat a first paint and a second paint in two layers on the surface of the abovementioned web.

2. Description of the Related Art

By way of example, as a coater for the coating of a first paint and a second paint of different characteristics in two layers on a web (template) surface for the purpose of producing a thermo-sensitive paper formed by the coating of a thermo-sensitive paint as a color-forming layer and a resin paint as a protective layer on the surface of a web (template) or an art paper or coated paper or the like formed by the coating of an undercoat paint and a topcoat paint on the surface of a web (template), a 2-layer curtain coater A such as that illustrated in FIGS. 4a-4b has previously been proposed.

In this 2-layer curtain coater A, in which a twin-type curtain nozzle N is arranged in the region above a transported web W, a first paint curtain C1c is formed from a first paint C1 supplied to a first nozzle head Nh1 of said curtain nozzle N and, in addition, a second paint curtain C2c is formed from a second paint C2 supplied to a second nozzle head Nh2 of the abovementioned curtain nozzle N, a first paint layer C1l and a second paint layer C2l are overcoated in two layers on the surface Ws of a web W by, as illustrated in FIG. 4b, the supply of a 2-layered paint curtain F formed by the union of the first paint curtain C1c and the second paint curtain C2c to the abovementioned surface Ws of the web W transported in the direction of the arrow X.

However, in the curtain coaters of the prior art, the paint must flow continuously from the nozzle in order to prevent soiling of the nozzle by the paint and, in addition, in order to prevent drying and solidification of part of the paint as a result of the infiltration of air into the nozzle when the painting is suspended, a paint curtain must be continuously formed by the flow of paint through the nozzle throughout not only, of course, the coating operation, but also throughout coating preparation as well.

Furthermore, in the curtain coaters of the prior art, when the flow of paint to the nozzle is begun in the initiation thereof from the suspended state, the flow of paint from the nozzle must be continued prior to the initiation of the coating until the flow of paint stabilizes and a stationary state paint curtain is formed.

For this reason, in the above-described 2-layer curtain coater A, the 2-layer paint curtain F supplied from the curtain nozzle N during the coating preparation as illustrated in FIG. 4a is recovered using a recovery pan P that is moved from a withdrawn position to a position below the curtain nozzle N as illustrated in FIG. 4b.

However, because the 2-layered paint curtain F supplied from the curtain nozzle N is formed from the first paint curtain C1c and the second paint curtain C2c, the independent recovery of the first paint C1 and the second paint C2 is very difficult.

That is to say, because the first paint C1 and second paint C2 that flow through the curtain nozzle N during coating preparation become mixed with each other during the recovery thereof and their re-use is difficult, using the 2-layer curtain coaters A of the prior art the excessive consumption of the first paint C1 and second paint C2 during coating preparation is an unavoidable problem.

What is needed in the art is a 2-layer curtain coater that affords the prevention of paint loss in the coating operation.

### SUMMARY OF THE INVENTION

The present invention provides a 2-layer curtain coater that supplies a 2-layered paint curtain formed from a first paint curtain and a second paint curtain to the surface of a transported web to overcoat a first paint and a second paint in two layers on the surface of the abovementioned web. The 2-layer curtain coater includes a first curtain nozzle for the forming of the first paint curtain and a second curtain nozzle for the forming of the second paint curtain and, in addition, in that the first curtain nozzle and the second curtain nozzle are relatively movable between a segregated coating preparation position and a merged coating operation position. In the coating preparation position, the first paint and the second paint are recovered in a state independent of each other by the recovery of the first paint curtain from the first curtain nozzle by way of a first recovery pan and the recovery of the second paint curtain from the second curtain nozzle by way of a second recovery pan. In the coating operation position, the 2-layered paint curtain is formed from the first paint curtain from the first curtain nozzle and the second paint curtain from the second curtain nozzle to overcoat the first paint and the second paint in two layers on the surface of the web.

By virtue of the fact that, based on the 2-layer curtain coater pertaining to the present invention, the first curtain nozzle and second curtain nozzle are moved to a segregated coating preparation position during coating preparation and the first paint curtain from the first curtain nozzle is recovered by the first recovery pan and the second paint curtain from the second curtain nozzle is recovered by the second recovery pan to afford the recovery of the first paint and second paint in a state independent of each other without mixing, the recovered first paint and second paint can be re-used and, as a result, paint loss during coating preparation can be prevented.

An advantage of the present invention is that the 2-layer curtain coater is able to prevent paint loss during coating preparation.

### BRIEF DESCRIPTION OF THE DRAWINGS

The above-mentioned and other features and advantages of this invention, and the manner of attaining them, will become more apparent and the invention will be better understood by reference to the following description of embodiment of the invention taken in conjunction with the accompanying drawings, wherein:

FIG. 1 is a schematic diagram illustrating a first embodiment of the 2-layer curtain coater pertaining to the present invention;

FIG. 2 is a schematic diagram illustrating the actuated state of the 2-layer curtain coater illustrated in FIG. 1;

FIG. 3 is a schematic diagram illustrating the actuated state of the 2-layer curtain coater illustrated in FIG. 1; and

FIGS. 4a and 4b are schematic diagrams of a 2-layer curtain coater of the prior art.

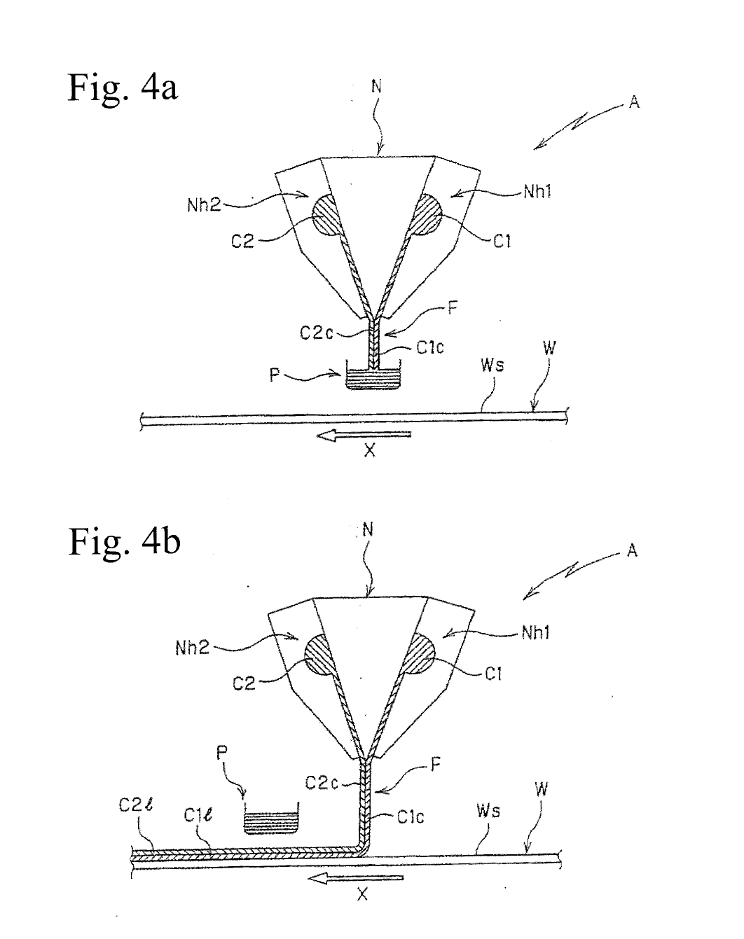

Corresponding reference characters indicate corresponding parts throughout the several views. The exemplifications set out herein illustrate one embodiment of the invention, and such exemplifications are not to be construed as limiting the scope of the invention in any manner.

### DETAILED DESCRIPTION OF THE INVENTION

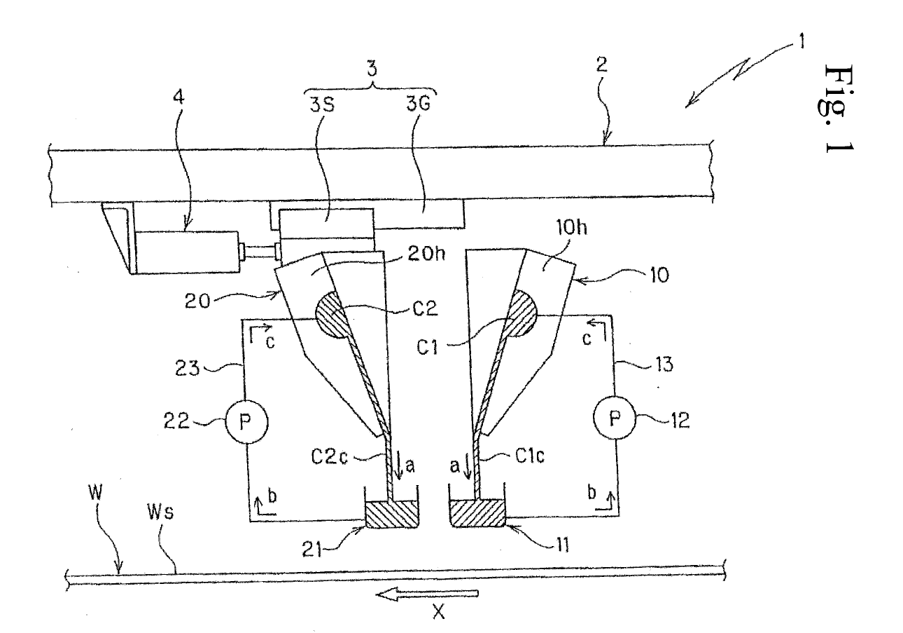

Referring now to the drawings, and more particularly to FIGS. 1 to 3, there is shown one embodiment of the 2-layer curtain coater pertaining to the present invention, the 2-layer curtain coater 1 including a first curtain nozzle 10 and a second curtain nozzle 20 arranged in a region above a transported web (template) W.

The abovementioned first curtain nozzle 10 and second curtain nozzle 20 are juxtaposedly arranged along the direction in which the web W is transported which is indicated by the arrow X, and the abovementioned first curtain nozzle 10, which serves as a device for the forming of a first paint curtain C1c from a first paint C1 supplied to a nozzle head 10h, is fixedly-arranged in a prescribed position in a region above the web W.

On the other hand, the abovementioned second curtain nozzle 20, which serves as a device for the forming of a second paint curtain C2c from a second paint C2 supplied to a nozzle head 20h, is arranged in the downstream side of the above-described second curtain nozzle 20 in the direction of carry of the web W.

In addition, the abovementioned second curtain nozzle 20 is movably supported in an upper beam (bar) 2 that extends in the direction of transportation of the web W by way of a guide structure 3 configured from a guide way 3G and slider 3S in a mode by which it approaches and separates from the abovementioned first curtain nozzle 10.

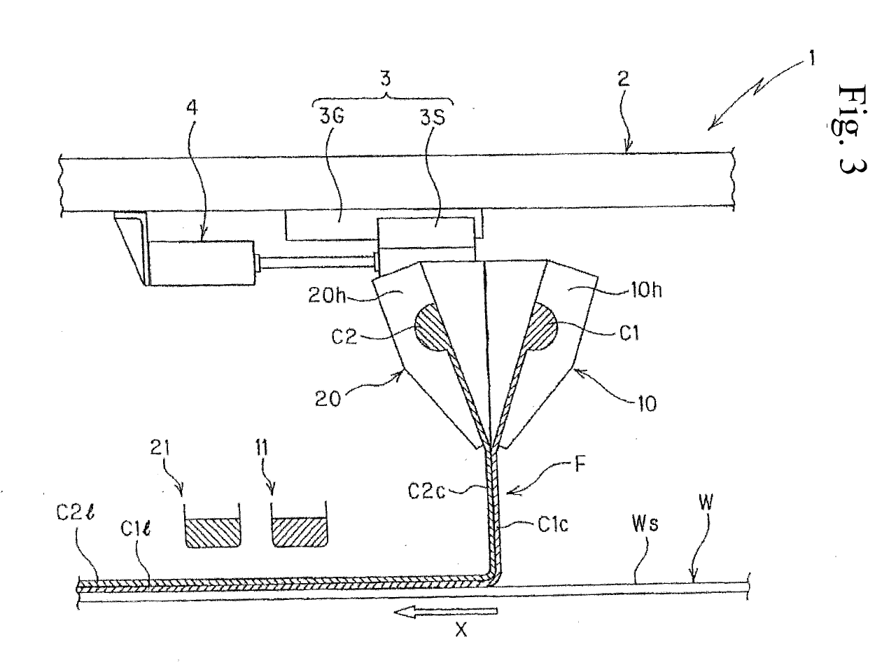

Furthermore, the abovementioned second curtain nozzle 20 moves between a position for coating preparation where it is separated from the abovementioned first curtain nozzle 10 as illustrated in FIG. 1 and a position for coating operation where it is merged with the abovementioned first curtain nozzle 10 as illustrated in FIG. 3 in response to the operation of a cylinder actuator 4 interposed between itself and the abovementioned beam 2.

Thereupon, when the fixedly-arranged first curtain nozzle 10 moves relatively to the abovementioned second curtain nozzle 20 by the movement of said second curtain nozzle 20 and the second curtain nozzle 20 occupies the coating preparation position, the fixed position of the first curtain nozzle 10 is the coating preparation position and, in addition, when the second curtain nozzle 20 occupies the coating operation position, the fixed position of the curtain nozzle 10 is the coating operation position.

As is illustrated in FIG. 1, in the state in which the first curtain nozzle 10 and second curtain nozzle 20 occupy a separated coating preparation position, a first recovery pan 11 and a second recovery pan 21 occupy a position below the abovementioned first curtain nozzle 10 and second curtain nozzle 20 respectively.

The abovementioned first recovery pan 11 is connected to the first curtain nozzle 10 (nozzle head 10h) by a pipe 13 interposed in which is a pump 12 and, on the other hand, the abovementioned second recovery pan 21 is connected to the nozzle head 20h of a second curtain nozzle 20 by a pipe 23 interposed in which is a pump 22.

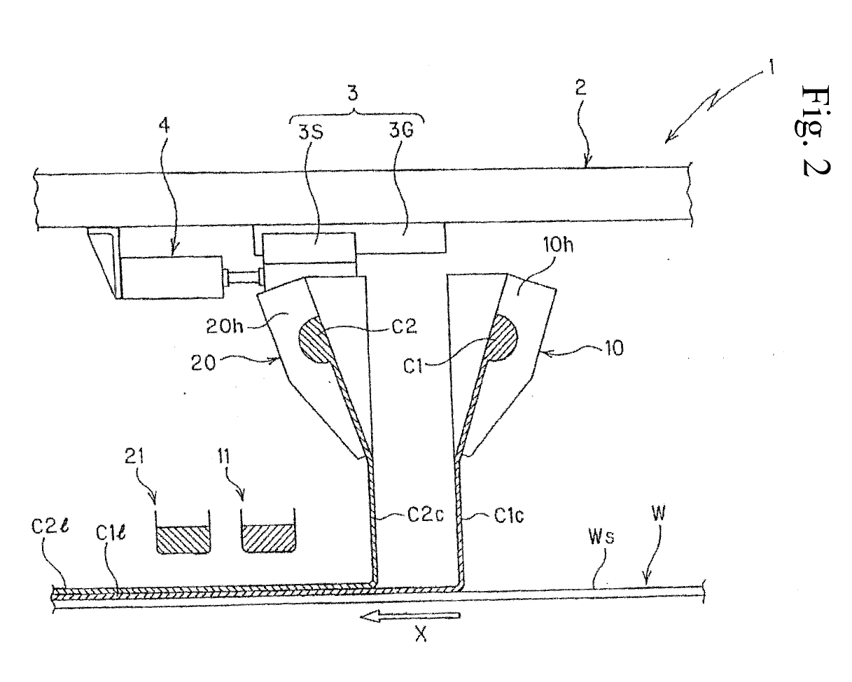

In addition, the abovementioned first recovery pan 11 and the second recovery pan 21 are configured in such a way as to be moveable by a guide structure and a drive structure (not shown in the diagram) between a working position directly below the first curtain nozzle 10 and second curtain nozzle 20 where the coating preparation position is occupied (FIG. 1) and a withdrawn position illustrated by FIG. 2 and FIG. 3, that is to say, a positioned removed from directly below the first curtain nozzle 10 and second curtain nozzle 20 where the coating preparation position and the coating operation position are occupied.

As is illustrated in FIG. 1, during coating preparation using the 2-layer curtain coater 1 of the above-described configuration, the first curtain nozzle 10 and second curtain nozzle 20 are caused to occupy the separated coating preparation position and, in addition, the first recovery pan 11 and second recovery pan 21 are caused to occupy the working position directly below the first curtain nozzle 10 and second curtain nozzle 20.

Thereupon, also during the coating preparation, a first paint curtain C1c formed from a first paint C1 supplied to the nozzle head 10h flows downward from the first curtain nozzle 10 and, in addition, a second paint curtain C2c formed from a second paint C2 supplied to the nozzle head 20h flows downward from a second curtain nozzle 20.

The first paint curtain C1c that flows downward from the first curtain nozzle 10 is recovered by the first recovery pan 11, and the first paint C1 stored in said first recovery pan 11 is circulated to the nozzle head 10h of the first curtain nozzle 10 by way of the pipe 13 by the operation of the pump 12.

In addition, the second paint curtain C2c that flows downward from the second curtain nozzle 20 is recovered by the second recovery pan 21, and the second paint C2 stored in said second recovery pan 21 is circulated to the nozzle head 20h of the second curtain nozzle 20 by way of the pipe 23 by the operation of the pump 22.

In this way, during coating preparation, the first paint C1 that flows out from the first curtain nozzle 10 and the second paint C2 that flows out from the second curtain nozzle 20 are recovered in a state independent of each other by the first recovery pan 11 and second recovery pan 21 and, moreover, are able to be effectively re-used as a result of the circulation thereof as indicated by each of the arrows a, b and c between the first curtain nozzle 10 and first recovery pan 11 and between the second curtain nozzle 20 and the second recovery pan 21.

On the other hand, when the coating operation of the above-described 2-layer curtain coater 1 is initiated, first, as illustrated in FIG. 2, the first recovery pan 11 and second recovery pan 21 move from the working position to the withdrawn position (FIG. 1) following which, as illustrated in FIG. 3, the first curtain nozzle 10 and second curtain nozzle 20 are moved from the coating preparation position to the coating operation position (FIG. 1).

In the state illustrated in FIG. 2, first, a coating of the first paint layer C1l is formed as a result of the supply of the first paint curtain C2c that flows down from the first curtain nozzle 10 to the surface Ws of the web W transported in the direction of the arrow X, following which, by the supply of the second paint curtain C2c that flow downs from the second curtain nozzle 20 over the first paint layer C1l, the first paint C1 and second paint C2 are overcoated in two layers on the web surface Ws of the web W.

After this, in the merged state of the first curtain nozzle 10 and second curtain nozzle 20 resulting from the movement from the coating preparation position illustrated in FIG. 1 to the coating operation position illustrated in FIG. 3, by the formation of a 2-layered paint curtain F configured from the first paint curtain C1c that flows down from the first curtain nozzle 10 and the second paint curtain C2c that flows down from the second curtain nozzle 20 and, in addition, the supply of the 2-layered paint curtain F to the surface Ws of the web W which is transported in the direction of the arrow X, the first paint layer C1l and second paint layer C2l are overcoated in two layers on said surface Ws of the web W.

By virtue of the fact that, during the coating preparation based on the 2-layer curtain coater 1 of the embodiment pertaining to the present invention as described in detail above, the first curtain nozzle 10 and the second curtain nozzle 20 are moved to a separated coating preparation position, the first paint curtain C1c from the first curtain nozzle 10 is recovered by the first recovery pan 11 and the second paint curtain C2c from the second curtain nozzle 20 is recovered by the second recovery pan 21 so that the first paint C1 and second paint C2 are recovered in a state independent of each other without mixing, the recovered first paint C1 and second paint C2 can be re-used without alteration and, accordingly, paint loss can be prevented during coating preparation.

It should be noted that although, in the 2-layer curtain coater 1 of this embodiment, the first curtain nozzle 10 is fixedly-arranged and the second curtain nozzle 20 is freely movable, provided the first curtain nozzle 10 and the second curtain nozzle 20 are relatively movable between the separated coating preparation position and the merged coating operation position, the second curtain nozzle 20 may be fixedly-arranged and the first curtain nozzle 10 may be movable, or both the first curtain nozzle 10 and the second curtain nozzle 20 may be movable.

In addition, although a cylinder actuator 4 is employed in the 2-layer curtain coater 1 of this embodiment as the way for moving the second curtain nozzle 20, it goes without saying that various drive ways other than a cylinder actuator may be adopted as a way for the relative movement of the first curtain nozzle 10 and second curtain nozzle 20 such as, by way of example, a ball screw structure.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### EXPLANATION OF CERTAIN SYMBOLS

1 2-layer curtain coater
10 First curtain nozzle
11 First recovery pan
20 Second curtain nozzle
21 Second recovery pan
C1 First paint
C2 Second paint
C1c First paint curtain,
C2c Second curtain
C1l First paint layer
C2l Second paint layer
F 2-layer curtain coater
W Web
Ws Surface

What is claimed is:

1. A 2-layer curtain coater that supplies a 2-layered paint curtain formed from a first paint curtain and a second paint curtain to a surface of a transported web to overcoat a first paint and a second paint in two layers on the surface of the web, said 2-layer curtain coater system comprising:
a first curtain nozzle configured for forming the first paint curtain; and
a second curtain nozzle configured for forming the second paint curtain, said first curtain nozzle and said second curtain nozzle being relatively movable between a segregated coating preparation position and a merged coating operation position.

2. The 2-layer curtain coater of claim 1, wherein, in said segregated coating preparation position, the 2-layer curtain coater system is configured for recovering the first paint and the second paint in a state independent of each other.

3. The 2-layer curtain coater of claim 2, further comprising a first recovery pan configured for recovering the first paint curtain from said first curtain nozzle.

4. The 2-layer curtain coater of claim 3, further comprising a second recovery pan configured for recovering the second paint curtain from said second curtain nozzle.

5. The 2-layer curtain coater of claim 1, wherein, in said merged coating operation position, the 2-layered paint curtain includes the first paint curtain from said first curtain nozzle and the second paint curtain from said second curtain nozzle and is for overcoating the first paint and the second paint in the two layers on the surface of the web.
